(19) United States
(12) Patent Application Publication
(10) Pub. No.: US 2025/0278572 A1
(43) Pub. Date: Sep. 4, 2025

(54) GENERATING LARGE LANGUAGE MODEL PROMPTS BASED ON KNOWLEDGE GRAPHS

(71) Applicant: Optum, Inc., Minnetonka, MN (US)

(72) Inventors: Carlos Morato, Sammamish, WA (US); Sanjay Kumar Singh, Bengaluru (IN); Shibsankar Das, Begampur (IN)

(21) Appl. No.: 18/591,292

(22) Filed: Feb. 29, 2024

(51) Int. Cl. G06F 40/40; G06F 40/279; G06F 40/30

(52) U.S. Cl. CPC G06F 40/40; G06F 40/279; G06F 40/30

(57) ABSTRACT

Various embodiments of the present disclosure provide methods, apparatus, systems, computing devices, computing entities, and/or the like for (i) generating document-topic-entity relationship features that are associated with a plurality of topics, a plurality of entities, and a plurality of documents, (ii) generating knowledge graph data objects based on the document-topic-entity relationship features, (iii) generating prompt elements based on a query input, the prompt elements comprising (a) context data associated with one or more query topics, one or more query entities, or one or more query documents and (b) the knowledge graph data objects, (iv) generating, using a natural language processing machine learning model, one or more subgraph data objects based on the prompt elements, and (v) providing, one or more answer outputs based on the one or more subgraph data objects.

### BACKGROUND

Traditional search systems, such as large language model (LLM)-based search systems, are designed for broad domain inquiries and encounter difficulties in resolving dependent contexts or topic hopping within a same document. Furthermore, traditional search systems are unable to synthesize information that are spread across various heterogeneous documents. LLMs are typically configured to predict a next syntactically correct word or phrase and are often not able to wholly interpret human meaning. As such, when applied to heterogenous documents, an LLM may generate an output that is false or does not match an intent of a query (sometimes referred to as a “hallucination”).

Various embodiments of the present disclosure make important contributions to information retrieval and provide solutions that address the shortcomings of existing search solutions, among others.

### BRIEF SUMMARY

In general, various embodiments of the present disclosure provide methods, apparatus, systems, computing devices, computing entities, and/or the like for improving large search systems through graph-based information synthesis across heterogeneous documents.

Various embodiments of the present disclosure make important technical contributions to improving the predictive accuracy of predictive machine learning models by generating prompts based on context data and a reference to one or more knowledge graph data objects that are extracted from query inputs. As described herein, current search systems, such as traditional search systems based on large language models (LLMs), have difficulties in synthesizing information that are scattered across various documents and are not efficient in resolving dependent contexts or topic hopping within a same document. Accordingly, by generating prompts based on context data and a reference to one or more knowledge graph data objects that are extracted from query inputs, the techniques described herein improve accuracy of performing predictive operations as needed on data having topic-entity-document dependencies.

In some embodiments, a computer-implemented method comprises receiving, by one or more processors, one or more knowledge graph data objects comprising (i) a plurality of nodes associated with a plurality of topics, a plurality of entities, or a plurality of documents and (ii) a plurality of edges between the plurality of nodes; generating, by the one or more processors and based on a query input, one or more prompt elements by associating context data with the one or more knowledge graph data objects, wherein the context data is further associated with one or more query topics, one or more query entities, or one or more query documents; generating, by the one or more processors and using a natural language processing machine learning model, one or more subgraph data objects based on a prompt comprising the one or more prompt elements; and providing, by the one or more processors, one or more answer outputs based on the one or more subgraph data objects.

In some embodiments, a computing system comprises memory and one or more processors communicatively coupled to the memory, the one or more processors configured to receive one or more knowledge graph data objects comprising (i) a plurality of nodes associated with a plurality of topics, a plurality of entities, or a plurality of documents and (ii) a plurality of edges between the plurality of nodes; generate, based on a query input, one or more prompt elements by associating context data with the one or more knowledge graph data objects, wherein the context data is further associated with one or more query topics, one or more query entities, or one or more query documents; generate, using a natural language processing machine learning model, one or more subgraph data objects based on a prompt comprising the one or more prompt elements; and provide one or more answer outputs based on the one or more subgraph data objects.

In some embodiments, one or more non-transitory computer-readable storage media includes instructions that, when executed by one or more processors, cause the one or more processors to receive one or more knowledge graph data objects comprising (i) a plurality of nodes associated with a plurality of topics, a plurality of entities, or a plurality of documents and (ii) a plurality of edges between the plurality of nodes; generate, based on a query input, one or more prompt elements by associating context data with the one or more knowledge graph data objects, wherein the context data is further associated with one or more query topics, one or more query entities, or one or more query documents; generate, using a natural language processing machine learning model, one or more subgraph data objects based on a prompt comprising the one or more prompt elements; and provide one or more answer outputs based on the one or more subgraph data objects.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a flowchart diagram of an example process for generating answer outputs in accordance with some embodiments of the present disclosure.

FIG. 5 is a flowchart diagram of an example process for generating one or more document-topic-entity relationship features in accordance with some embodiments of the present disclosure.

FIG. 6 is a flowchart diagram of an example process for generating one or more document-topic-entity relationship features in accordance with some embodiments of the present disclosure.

FIG. 7 is a flowchart diagram of an example process for generating a plurality of similarity scores in accordance with some embodiments of the present disclosure.

FIG. 8 depicts an example architecture for determining a similarity score between a mention-context vector and topic-entity-mention vector pair in accordance with some embodiments of the present disclosure.

FIG. 9 is a flowchart diagram of an example process for providing sufficient knowledge to generate an answer output in accordance with some embodiments of the present disclosure.

FIG. 10 depicts an example search system architecture in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

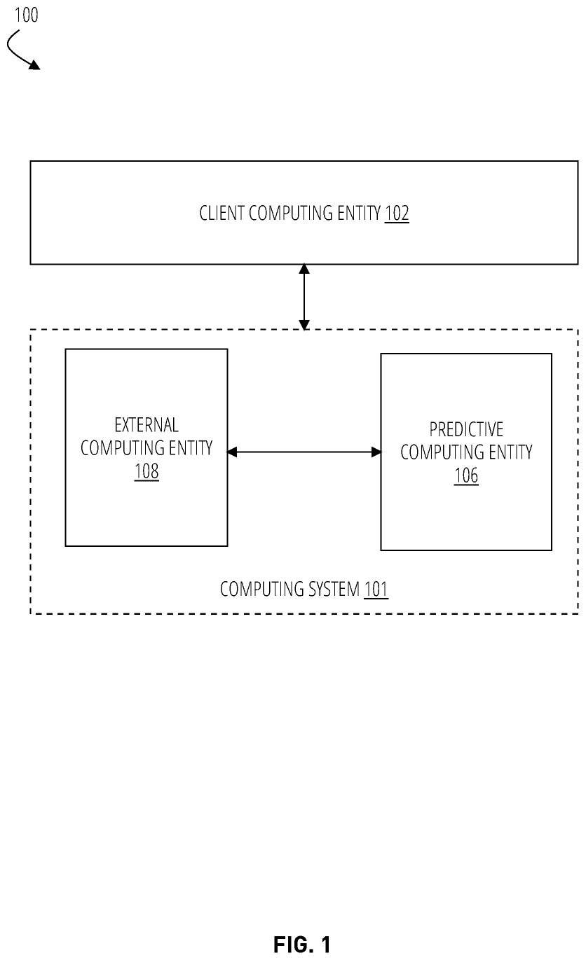

FIG. 1 provides an example overview of an architecture 100 in accordance with some embodiments of the present disclosure. The architecture 100 includes a computing system 101 configured to receive predictive data analysis/query requests from client computing entities 102, process the predictive data analysis/query requests to generate predictions and/or retrieve answer outputs based on the generated predictions, and provide the generated predictions and/or answer outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, a predictive machine learning model may be trained to generate one or more subgraph data objects based on a prompt comprising one or more prompt elements. The one or more prompt elements may comprise (i) context data associated with one or more query topics, one or more query entities, or one or more query documents and (ii) one or more knowledge graph data objects. The prompt may be used to direct the predictive machine learning model to generate an output by (i) extracting one or more nodes (e.g., topics, entities, and documents) from a prompt, (ii) classifying the one or more nodes into one or more subdomains, and (iii) generating one or more subgraph data objects for the one or more subdomains based on the classified nodes and one or more knowledge graph data objects. Accordingly, one or more answer outputs may be generated based on the one or more subgraph data objects. This technique will lead to higher accuracy of performing predictive operations as needed on data having topic-entity-document dependencies. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive predictive data analysis/query requests from client computing entities 102, process the predictive data analysis/query requests to generate predictions and/or retrieve answer outputs based on the generated predictions, and provide the generated predictions and/or answer outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or prediction operations of the present disclosure. In some examples, the external computing entities 108 may be configured to train, implement, use, update, and evaluate machine learning models in accordance with one or more training and/or prediction operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., data synthesis techniques, search techniques, and/or the like) described herein. The external computing entities 108, for example, may include and/or be associated with one or more entities that may be configured to receive, transmit, store, manage, and/or facilitate datasets, such as a dataset including a plurality of heterogeneous documents, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more prediction steps/operations of the present disclosure. In some examples, feedback (e.g., evaluation data, ground truth data, etc.) from the use the of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

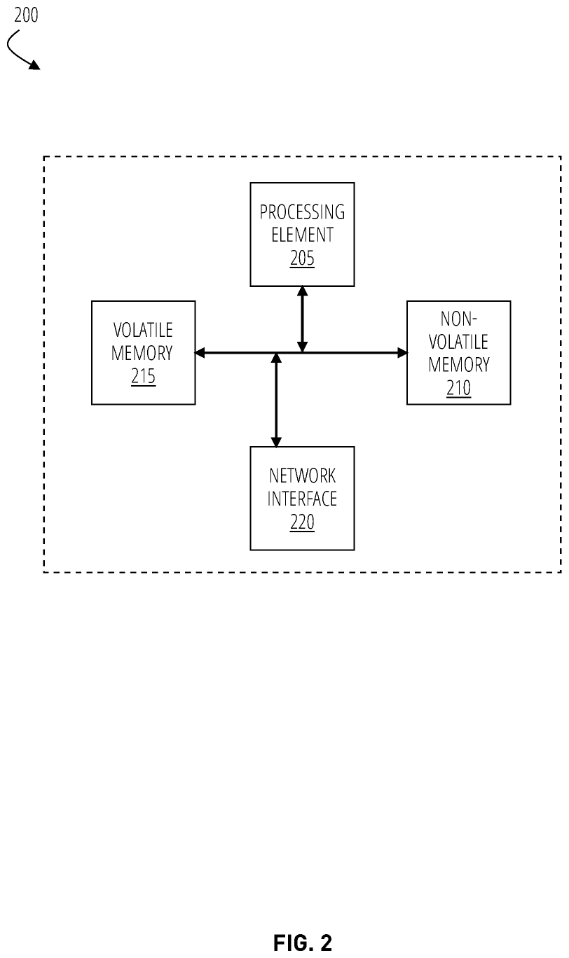

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning model(s) described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

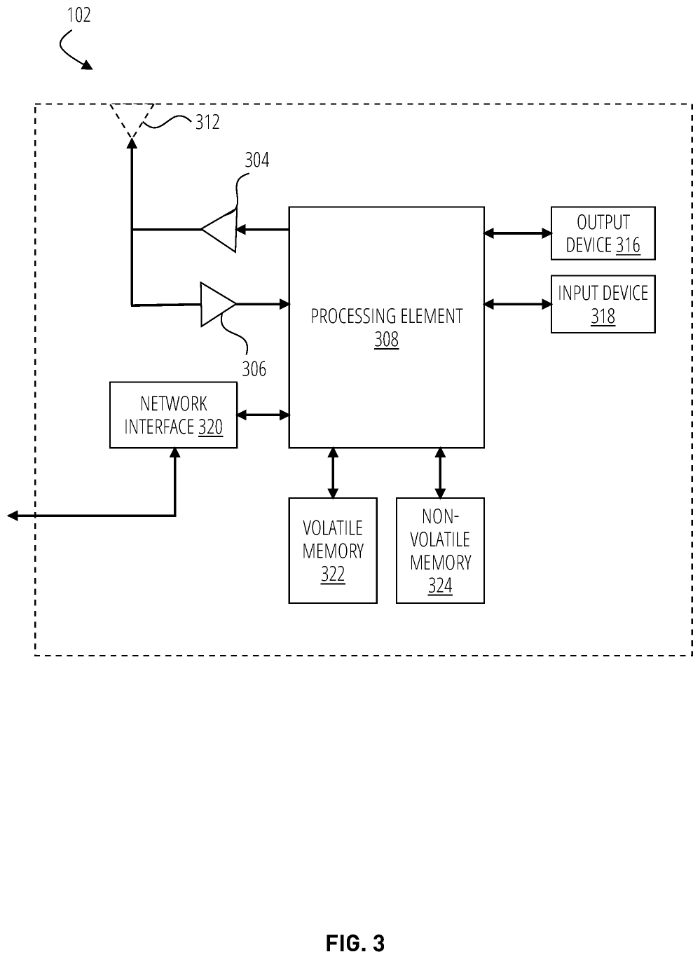

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “topic” refers to a data construct that describes a subject matter or description that is representative of content associated with at least a portion of a document. According to various embodiments of the present disclosure, the contents of a document may be characterized by one or more topics. For example, a document may comprise one or more content portions and the one or more content portions may be associated with one or more topics. In some embodiments, a plurality of topics within a document may or may not be related. In some embodiments, one or more topics may be associated with one or more entities. In some embodiments, a topic is ranked based on a topic randomness score.

In some embodiments, the term “entity” refers to a data construct that describes a subject of a topic, such as an object (either real-world or virtual (e.g., data object or file)), location, article, person, program, service, task, operation, computing entity, and/or the like unit. According to various embodiments of the present disclosure, one or more entities are associated with one or more documents based on one or more document-topic-entity relationship features. In some embodiments, an entity is ranked based on an entity quality score.

In some embodiments, the term “document” refers to a data construct that describes an electronic file comprising content or information. A document may be stored in a database and indexed for retrieval, e.g., by a search engine. For example, a document may comprise content that matches a query input. The content of a document may comprise one or more segments that are associated with one or more topics, and the one or more topics may be associated with one or more entities. According to various embodiments of the present disclosure, a document may be ranked with respect to one or more topics and one or more entities based on one or more document-topic-entity relationship features.

In some embodiments, the term “document-topic-entity relationship feature” refers to a data construct that describes a relationship between one or more documents, one or more topics, or one or more entities. According to various embodiments of the present disclosure, one or more document-topic-entity relationship features associated with a plurality of topics, a plurality of entities, and a plurality of documents are generated. In some embodiments, generating the one or more document-topic-entity relationship features comprises generating one or more of (i) a document-topic distribution matrix, (ii) a topic-entity-common word matrix, (iii) a plurality of topic-document weights, (iv) a plurality of entity-topic weights, (v) a plurality of topic randomness scores, (vi) a plurality of entity quality scores, or (vii) a plurality of similarity scores associated with a plurality of entities, a plurality of topics, and a plurality of documents. In some embodiments, generating the one or more document-topic-entity relationship features comprises normalizing a plurality of topics and a plurality of entities, from which the one or more document-topic-entity relationship features are generated based on. For example, one or more entities may be extracted from one or more documents in plain text (in a denormalized format, e.g., “United States,” “America,” and “US”) and normalized (to “USA”). In some embodiments, a knowledge base is generated based on one or more document-topic-entity relationship features that are associated with a plurality of topics, a plurality of entities, and a plurality of documents. In some embodiments, one or more subgraph data objects (e.g., for generating answer outputs) are generated by determining one or more documents and/or entities that are high ranking with respect to a query input based on one or more knowledge graph data objects and/or a knowledge base comprising one or more document-topic-entity relationship features and rankings associated with the one or more documents and/or entities.

In some embodiments, the term “document-topic distribution matrix” refers to a data construct that describes a distribution of a plurality of topics with respect to a plurality of documents. That is, a document-topic distribution matrix may comprise a plurality of representative probabilities associated with a plurality of given topics being present in a plurality of given documents. Each of a plurality of topics may or may not be present in a document. Topic presence may also vary from document to document. For example, some topics may find larger distributions in some documents, while other topics may only be related to specific (or fewer) documents.

In some embodiments, the term “topic-entity-common word matrix” refers to a data construct that describes a distribution of a plurality of entities within a plurality of common words that connect a plurality of topics with respect to the plurality of topics in a plurality of documents. For example, a topic-entity-common word matrix may comprise a plurality of representative probabilities associated with a plurality of given entities being present in list of common words that connect a plurality of given topics in a plurality of given documents. As such, a topic-entity-common word matrix may capture semantic relationships between a plurality of entities and a plurality of topics.

In some embodiments, the term “topic randomness score” refers to a data construct that describes a measure representative of a quality or purity of a topic in association with a plurality of documents. For example, some topics found in a document may comprise indirect references or background information (thereby comprising high randomness) while other topics may be prominent/specific to key information (thereby comprising low randomness). According to various embodiments of the present disclosure, a plurality of topic randomness scores is generated for a plurality of topics associated with a plurality of documents based on a plurality of topic-document weights. In some embodiments, a topic randomness score is generated by applying an entropy function to a plurality of topic-document weights. A lower topic randomness score (e.g., that is less than a given threshold) may be representative of a topic being pertinent to a document as a whole, while a higher topic randomness score (e.g., that is greater than a given threshold) may be representative of a topic comprising no significant association (e.g., a general topic) with a document as a whole. In some embodiments, topics associated with high topic randomness scores are filtered or removed from a distribution of topics with respect to a plurality of documents (e.g., document-topic distribution matrix). In some embodiments, topics associated with high topic randomness scores are retained in a distribution of topics with respect to a plurality of documents if the topics rarely occur in the plurality of documents.

In some embodiments, the term “topic-document weight” refers to a data construct that describes an amount of importance or relationship strength of a topic with respect to a document. A topic-document weight may be generated based on a distribution of an entity-related topic in a document. According to various embodiments of the present disclosure, a plurality of topic-document weights is generated for a plurality of topics based on a document-topic distribution matrix. In some embodiments, a plurality of topic-document weights may be assigned to a plurality of edges between a plurality of nodes in a knowledge graph data object, where the nodes are representative of topics, entities, or documents.

In some embodiments, the term “entity quality score” refers to a data construct that describes diversification and richness associated with an entity. According to various embodiments of the present disclosure, a plurality of entity quality scores is generated for a plurality of entities based a plurality of entity-topic weights. In some embodiments, an entity quality score is generated based on a summation comprising a plurality of probabilities associated with a plurality of entities being present within a plurality of common words that connect a plurality of topics with respect to a given topic, for a plurality of topics.

In some embodiments, the term “entity-topic weight” refers to a data construct that describes an amount of importance or relationship strength of an entity with respect to a topic. An entity-topic weight may be generated based on a semantic relation between an entity and a topic. According to various embodiments of the present disclosure, a plurality of entity-topic weights is generated for a plurality of entities with respect to a plurality of topics based on a topic-entity-common word matrix.

In some embodiments, the term “similarity score” refers to a data construct that describes a measure of how alike data objects are to each other. A similarity score may be generated by comparing one or more values of one or more data features that are associated with a first data object with respective one or more values of one or more data features that are associated with a second data object. According to various embodiments of the present disclosure, one or more knowledge graph data objects are generated based on a plurality of similarity scores associated with a plurality of entities, a plurality of topics, and a plurality of documents. In some embodiments, the plurality of similarity scores is generated based on a plurality of mention-context vector and topic-entity-mention vector pairs. In some embodiments, generating a similarity score between a mention-context vector and a topic-entity-mention vector (pair) comprises (i) generating one or more embeddings for one or more of a document, a mention, a topic, an entity word, or an entity class representation that are associated with the mention-context vector and topic-entity-mention vector pair, (ii) generating the mention-context vector and topic-entity-mention vector pair by combining respective ones of the one or more embeddings, and (iii) comparing the combined embeddings associated with the mention-context vector and topic-entity-mention vector pair based on a distance function. A distance function may comprise a mathematical formula that may be used to calculate a distance between the embeddings associated with the mention-context vector and topic-entity-mention vector pair, such as Euclidean distance, Manhattan distance, Minkowski distance, Jaccard distance, Cosine similarity, and any other types of distance measurements apparent to one of ordinary skill in the art.

In some embodiments, the term “query input” refers to a data construct that describes a request for information. For example, a query input may comprise one or more words, terms, or a string of characters, numbers, symbols, or any combination thereof, that may be entered by a user and received by a predictive data analysis system from one or more client computing entities, either directly or indirectly via, e.g., an information retrieval system comprising a search engine. A query input may be used by an information retrieval system to match the query input with a corpus of content items or data objects for retrieval. In some embodiments, a query input comprises one or more query topics, one or more query entities, or one or more query documents. According to various embodiments of the present disclosure, one or more prompt elements are generated based on one or more query topics, one or more query entities, or one or more query documents associated with a query input.

In some embodiments, the term “embedding” refers to a data construct that describes a latent representation of a data object. For example, an embedding may be expressed as a vector comprising one or more numbers representative of one or more data features or variables associated with a data object. In some embodiments, an embedding may be generated by mapping one or more data features of a data object to one or more elements in a feature vector space. According to various embodiments of the present disclosure, generating one or more document-topic-entity relationship features comprises generating a similarity score between a mention-context vector and topic-entity-mention vector pair by (i) generating one or more embeddings for one or more of a document, a mention, a topic, an entity word, or an entity class representation that are associated with the mention-context vector and topic-entity-mention vector pair, (ii) generating the mention-context vector and topic-entity-mention vector pair by combining respective ones of the one or more embeddings, and (iii) comparing the combined embeddings associated with the mention-context vector and topic-entity-mention vector pair based on a distance function.

In some embodiments, the term “knowledge graph data object” refers to a data construct that describes a network of one or more data elements and one or more relationships between the one or more data elements. In some embodiments, the one or more data elements comprise nodes that are representative of topics, entities, or documents. According to various embodiments of the present disclosure, a knowledge graph data object comprises a representation of interrelationships between topics, entities, and documents. In some embodiments, a knowledge graph data object comprises (i) a plurality of nodes associated with one or more topics, one or more entities, or one or more documents and (ii) a plurality of edges between the plurality of nodes. In some embodiments, a knowledge graph data object is generated based on one or more document-topic-entity relationship features. For example, weights and edges (e.g., links) between nodes of a knowledge graph data object may be generated based on one or more of (i) a document-topic distribution matrix, (ii) a plurality of topic-document weights for a plurality of topics with respect to a plurality of documents based on the document-topic distribution matrix, (iii) a plurality of topic randomness scores for the plurality of topics based on the plurality of topic-document weights, (iv) a topic-entity-common word matrix, (v) a plurality of entity-topic weights for a plurality of entities with respect to the plurality of topics based on the topic-entity-common word matrix, (vi) a plurality of entity quality scores for the plurality of entities based the plurality of entity-topic weights, or (vii) a plurality of similarity scores associated with the plurality of entities, the plurality of topics, or the plurality of documents. In some embodiments, one or more answer outputs are generated based on one or more knowledge graph data objects. In some example embodiments, a prompt is generated based on one or more prompt elements comprising one or more knowledge graph data objects from which one or more subgraph data objects are generated from and used to generate one or more answer outputs.

In some embodiments, the term “prompt element” refers to a data construct that describes a building block or component from which a prompt (e.g., usable to request a desired output from a machine learning model, such as a natural language processing machine learning model) may be generated from. A prompt element may comprise information associated with an aspect of a desired output to be generated by a machine learning model or necessary information for generating the desired output by the machine learning model. For example, a prompt may be generated based on one or more prompt elements comprising parameters for guiding, requesting, or directing a machine learning model towards a desired output. According to various embodiments of the present disclosure, one or more prompt elements are generated based on a query input, wherein a prompt is generated based on the one or more prompt elements. In some embodiments, the one or more prompt elements comprise one or more of (i) context data associated with one or more query topics, one or more query entities, or one or more query documents, (ii) one or more knowledge graph data objects, (iii) one or more historic queries, or (iv) one or more prompt templates.

In some embodiments, the term “prompt” refers to a data construct that describes information comprising one or more instructions that may be used to interact with a machine learning model, such as a natural language processing machine learning model, to define a desired output. That is, a prompt may be used to provide a machine learning model with information the machine learning model needs to generate a desired output. For example, a machine learning model may generate an answer to a question (or a response to a query) based on a prompt comprising context, rules, parameters, steps, or actions for generating the output. According to various embodiments of the present disclosure, one or more subgraph data objects are generated, using a natural language processing machine learning model, based on a prompt comprising one or more prompt elements. In some embodiments, one or more answer outputs are generated based on the one or more subgraph data objects. In some embodiments, a prompt comprises instructions for directing a machine learning model to generate an output by (i) extracting one or more nodes (e.g., topics, entities, and documents) from a prompt, (ii) classifying the one or more nodes into one or more subdomains, and (iii) generating one or more subgraph data objects for the one or more subdomains based on the classified nodes and one or more knowledge graph data objects.

In some embodiments, the term “prompt template” refers to a data construct that describes a sample prompt comprising predefined information or instructions. In some embodiments, a prompt is generated based on a prompt element comprising one or more prompt templates. In some embodiments, a prompt is generated by selecting a prompt template and populating the prompt template with information or instructions based on one or more prompt elements that are generated based on a query input.

In some embodiments, the term “context data” refers to a data construct that describes information associated with a set of facts or circumstances that are used to guide (e.g., via a prompt) a machine learning model, such as a natural language processing machine learning model, to generate an output.

In some embodiments, the term “historic query” refers to a data construct that describes a query input that has been previously received by a query input receiving system, such as an information retrieval system and/or a search engine.

In some embodiments, the term “subgraph data object” refers to a data construct that describes a network of one or more data elements (e.g., nodes and edges associated with topics, entities, or documents) and one or more relationships between the one or more data elements, wherein the one or more data elements and the one or more relationships are extracted, by a machine learning model, based on one or more knowledge graph data objects. In some embodiments, one or more subgraph data objects (e.g., for generating answer outputs) are generated by determining one or more documents and/or entities that are high ranking with respect to a query input based on one or more knowledge graph data objects and/or a knowledge base comprising one or more document-topic-entity relationship features and rankings associated with the one or more documents and/or entities. In some embodiments, generating one or more subgraph data objects comprises determining one or more attributes, such as radius of graph, graph periphery or node pairwise short path length, that are associated with one or more edges between documents and/or entities from one or more knowledge graph data object. In some embodiments, generating one or more subgraph data object comprises (i) generating a prompt based on one of one or more prompt templates, (ii) generating a question based on the one or more prompt templates and one or more of (a) context data associated with a query input, (b) one or more knowledge graph data objects, or (c) one or more historic queries, and (iii) generating, using a natural language processing machine learning model, an answer based on the question.

In some embodiments, the term “answer output” refers to a data construct that describes a response to a query input. For example, an answer output may comprise any one of information, predictions, or content items (e.g., provided as search results). According to various embodiments of the present disclosure, one or more answer outputs are generated based on one or more subgraph data objects. In some embodiments, generating the one or more answer outputs comprises traversing the one or more subgraph data objects and identifying one or more entities and/or one or more documents from the one or more subgraph data objects that are relevant to a query input based on the traversal of the one or more subgraph data objects. In some embodiments, generating an answer output comprises (i) determining an amount of the one or more subgraph data objects is zero or exceeds a threshold representative of the query input comprising an ambiguity, (ii) generating a follow-up question based on the query input, the one or more subgraph data objects, or the one or more knowledge graph data objects, (iii) receiving a response to the follow-up question, (iv) generating one or more follow-up prompt elements based on the response, and (v) adding one or more nodes or edges to one or more knowledge graph data objects, associated with the one or more subgraph data objects, based on the one or more follow-up prompt elements.

In some embodiments, the term “natural language processing machine learning model” refers to a data construct that describes parameters, hyperparameters, and/or defined operations of a machine learning model that is configured to recognize, translate, predict, or generate text or other content. For example, a natural language processing machine learning model may be used for text classification, question answering, document summarization, and text generation. According to various embodiments of the present disclosure, a natural language processing machine learning model is configured to generate one or more subgraph data objects based on a prompt comprising one or more prompt elements. In some embodiments, a natural language processing machine learning model comprises a transformer machine learning model that is configured to receive an input, encode the input (e.g., via an encoder), and decode the encoded input (e.g., via a decoder) to produce an output prediction. In some embodiments, a natural language processing machine learning model may be trained on a voluminous amount of datasets (e.g., an LLM).

### IV. OVERVIEW

Various embodiments of the present disclosure make important technical contributions to predictive text analysis that address the efficiency and reliability shortcomings of existing predictive text analysis solutions. For example, some techniques of the present disclosure improve the predictive accuracy of predictive machine learning models used in generating responses to search queries. To do so, the predictive machine learning models may be trained to generate subgraph data objects based on prompts that are generated based on context data and knowledge graph data objects extracted from query inputs. As such, information associated with relationships and rankings of a plurality of topics, entities, and documents may be provided through query inputs and leveraged to construct a prompt that is tailored to context and dependencies (e.g., of heterogeneous documents, such as longitudinal health records from documents consisting of clinical claims, pharmacy, EMR, behavior, etc.) that are specific to a particular task without additional training or fine-tuning of the predictive machine learning models. By doing so, some of the techniques of the present disclosure improve the training speed and training efficiency of training predictive machine learning models while improving the predictive performance of the resulting models.

It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative machine learning model architectures. Accordingly, some of the techniques of the present disclosure that improve predictive accuracy without harming training speed, such as the techniques described herein, enable improving training speed given an improved predictive accuracy. In doing so, some of the techniques described herein improve efficiency and speed of training predictive machine learning models, thus reducing the number of computational operations needed and/or the amount of training data entries needed to train predictive machine learning models. Accordingly, some of the techniques described herein improve the computational efficiency, storage-wise efficiency, and/or speed of training machine learning models, while improving the model's predictive performance.

Various embodiments of the present disclosure improve predictive accuracy of predictive machine learning models by generating prompts based on context data and a reference to one or more knowledge graph data objects that are extracted from query inputs. As described herein, current search systems, such as traditional search systems based on LLMs, have difficulties in synthesizing information that are scattered across various documents and are not very efficient in resolving dependent contexts or topic hopping within a same document.

In accordance with various embodiments of the present disclosure, a predictive machine learning model may be trained to generate subgraph data objects based on prompts that are generated based on context data and knowledge graph data objects. As such, information associated with relationships and rankings of a plurality of topics, entities, and documents may be provided by the context data and knowledge graph data objects and leveraged to construct a prompt that is tailored to context and dependencies (e.g., of heterogeneous documents, such as longitudinal health records from documents consisting of clinical claims, pharmacy, EMR, behavior, etc.) that are specific to a particular task without additional training or fine-tuning of the predictive machine learning models. In this manner, some of the techniques of the present disclosure, improve accuracy of performing predictive operations as needed on data having topic-entity-document dependencies.

In accordance with various embodiments of the present disclosure, predictions may be generated for a plurality of documents or entities based on prompts comprising context data and knowledge graph data objects extracted from query inputs. By doing so, input to predictive machine learning models may be refined to guide generation of outputs that incorporate data relationships without additional training. In this way, some of the techniques of the present disclosure may be practically applied, in real time, to improve content generation of predictive machine learning models, such as answer outputs, relative to traditional search engines.

Moreover, some of the techniques (e.g., the prompt generation techniques, subgraph generation techniques, etc.) of the present disclosure reduce the number of computational operations needed and/or the amount of training data entries needed to train predictive machine learning models. Accordingly, the techniques described herein improve the computational efficiency, storage-wise efficiency, and/or speed of training predictive machine learning models. Other technical improvements and advantages may be realized by one of ordinary skill in the art.

Examples of technologically advantageous embodiments of the present disclosure include: (i) subgraph generation techniques that leverage knowledge graph data objects to generate improved predictions, (ii) prompt element extraction from query input techniques for generating improved prompts, and (iii) prompts for improving model accuracy while reducing computational resource usage, among others. Other technical improvements and advantages may be realized by one of ordinary skill in the art.

### V. EXAMPLE SYSTEM OPERATIONS

As indicated, various embodiments of the present disclosure make important technical contributions to improving the predictive accuracy of predictive machine learning models by generating prompts based on context data and a reference to one or more knowledge graph data objects that are extracted from query inputs. By doing so, input to predictive machine learning models may be refined to guide generation of outputs that incorporate data relationships without additional training. In this way, some of the techniques of the present disclosure may be practically applied, in real time, to improve content generation of predictive machine learning models, such as answer outputs, relative to traditional search engines.

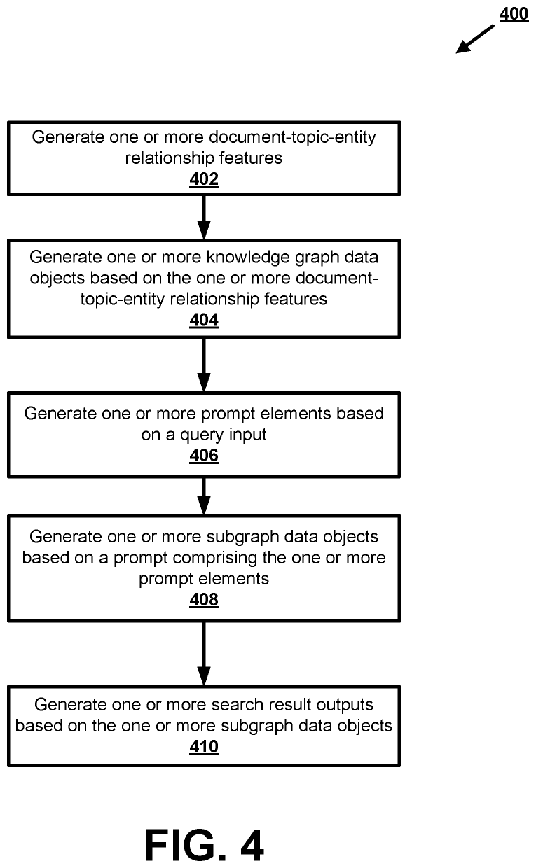

FIG. 4 is a flowchart diagram of an example process 400 for generating answer outputs in accordance with some embodiments of the present disclosure.

In some embodiments, the process 400 begins at step/operation 402 when the computing entity 200 generates one or more document-topic-entity relationship features associated with a plurality of topics, a plurality of entities, and a plurality of documents.

In some embodiments, a document-topic-entity relationship feature describes a relationship between one or more documents, one or more topics, or one or more entities.

In some embodiments, a topic describes a subject matter or description that is representative of content associated with at least a portion of a document. According to various embodiments of the present disclosure, the contents of a document may be characterized by one or more topics. For example, a document may comprise one or more content portions and the one or more content portions may be associated with one or more topics. In some embodiments, a plurality of topics within a document may or may not be related. In some embodiments, one or more topics may be associated with one or more entities. In some embodiments, a topic is ranked based on a topic randomness score.

In some embodiments, an entity describes a subject of a topic, such as an object (either real-world or virtual (e.g., data object or file)), location, article, person, program, service, task, operation, computing entity, and/or the like unit. According to various embodiments of the present disclosure, one or more entities are associated with one or more documents based on one or more document-topic-entity relationship features. In some embodiments, an entity is ranked based on an entity quality score.

In some embodiments, a document describes an electronic file comprising content or information. A document may be stored in a database and indexed for retrieval, e.g., by a search engine. For example, a document may comprise content that matches a query input. The content of a document may comprise one or more segments that are associated with one or more topics, and the one or more topics may be associated with one or more entities. According to various embodiments of the present disclosure, a document may be ranked with respect to one or more topics and one or more entities based on one or more document-topic-entity relationship features.

In some embodiments, generating the one or more document-topic-entity relationship features comprises normalizing a plurality of topics and a plurality of entities, from which the one or more document-topic-entity relationship features are generated based on. For example, one or more entities may be extracted from one or more documents in plain text (in a denormalized format, e.g., “United States,” “America,” and “US”) and normalized (to “USA”). In some embodiments, a knowledge base is generated based on one or more document-topic-entity relationship features that are associated with a plurality of topics, a plurality of entities, and a plurality of documents.

In some embodiments, generating the one or more document-topic-entity relationship features comprises generating one or more of (i) a document-topic distribution matrix (M_{dt}), (ii) a topic-entity-common word matrix (T_{ecwd}), (iii) a plurality of topic-document weights (W_{dt}), (iv) a plurality of entity-topic weights (Wₜₑ), (v) a plurality of topic randomness scores, (vi) a plurality of entity quality scores, or (vii) a plurality of similarity scores associated with a plurality of entities, a plurality of topics, and a plurality of documents.

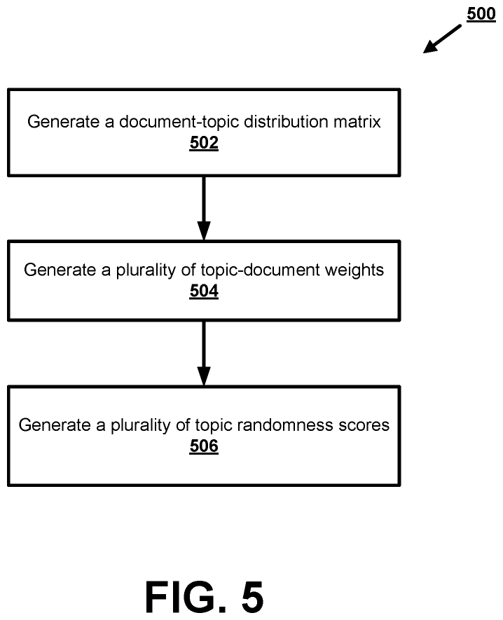

FIG. 5 is a flowchart diagram of an example process 500 for generating one or more document-topic-entity relationship features in accordance with some embodiments of the present disclosure.

In some embodiments, the process 500 begins at step/operation 502 when the computing entity 200 generates a document-topic distribution matrix that comprises a distribution of the plurality of topics with respect to the plurality of documents. In some embodiments, a document-topic distribution matrix describes a distribution of a plurality of topics with respect to a plurality of documents. That is, a document-topic distribution matrix may comprise a plurality of representative probabilities associated with a plurality of given topics being present in a plurality of given documents. Each of a plurality of topics may or may not be present in a document. Topic presence may also vary from document to document. For example, some topics may find larger distributions in some documents, while other topics may only be related to specific (or fewer) documents.

In some embodiments, at step/operation 504, the computing entity 200 generates a plurality of topic-document weights for the plurality of topics with respect to the plurality of documents based on the document-topic distribution matrix. In some embodiments, a topic-document weight describes an amount of importance or relationship strength of a topic with respect to a document. A topic-document weight may be generated based on a distribution of an entity-related topic in a document. According to various embodiments of the present disclosure, a plurality of topic-document weights is generated for a plurality of topics based on a document-topic distribution matrix. In some embodiments, a plurality of topic-document weights may be assigned to a plurality of edges between a plurality of nodes in a knowledge graph data object, where the nodes are representative of topics, entities, or documents.

In some embodiments, a topic-document weight is determined based on the following:

$${W}_{dt} ( {d}_{i} , {t}_{j} ) = {θ}_{i , j} \qquad Equation 1$$

where θ_{i,j} is the element in ith row and jth column of document-topic distribution matrix M_{dt}.

In some embodiments, at step/operation 506, the computing entity 200 generates a plurality of topic randomness scores for the plurality of topics based on the plurality of topic-document weights. In some embodiments, a topic randomness score describes a measure representative of a quality or purity of a topic in association with a plurality of documents. For example, some topics found in a document may comprise indirect references or background information (thereby comprising high randomness) while other topics may be prominent/specific to key information (thereby comprising low randomness). According to various embodiments of the present disclosure, a plurality of topic randomness scores is generated for a plurality of topics associated with a plurality of documents based on a plurality of topic-document weights. In some embodiments, a topic randomness score is generated by applying an entropy function to a plurality of topic-document weights. A lower topic randomness score (e.g., that is less than a given threshold) may be representative of a topic being pertinent to a document as a whole, while a higher topic randomness score (e.g., that is greater than a given threshold) may be representative of a topic comprising no significant association (e.g., a general topic) with a document as a whole. In some embodiments, topics associated with high topic randomness scores are filtered or removed from a distribution of topics with respect to a plurality of documents (e.g., document-topic distribution matrix). In some embodiments, topics associated with high topic randomness scores are retained in a distribution of topics with respect to a plurality of documents if the topics rarely occur in the plurality of documents.

In some embodiments, a topic randomness score is determined based on the following:

$$Topic Randomness ( {t}_{i} ) = {\sum }_{j = 1}^{\vert D \vert} {θ}_{j , i} {log}_{2} {θ}_{j , i} \qquad Equation 2$$

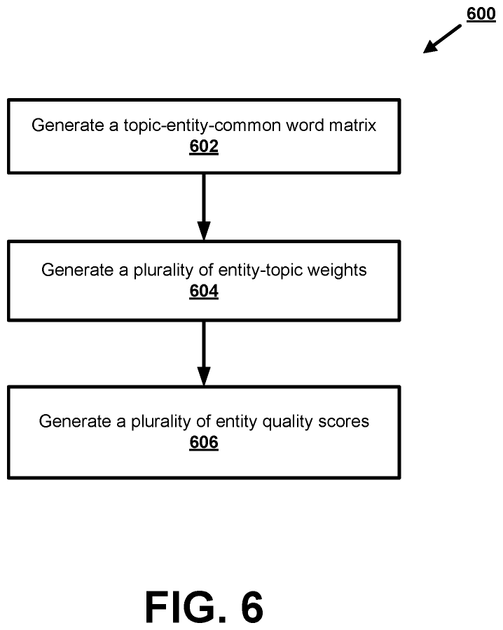

FIG. 6 is a flowchart diagram of an example process 600 for generating one or more document-topic-entity relationship features in accordance with some embodiments of the present disclosure.

In some embodiments, the process 600 begins at step/operation 602 when the computing entity 200 generates a topic-entity-common word matrix comprising a distribution of the plurality of entities within a plurality of common words that connect the plurality of topics with respect to the plurality of topics in the plurality of documents. In some embodiments, a topic-entity-common word matrix describes a distribution of a plurality of entities within a plurality of common words that connect a plurality of topics with respect to the plurality of topics in a plurality of documents. For example, a topic-entity-common word matrix may comprise a plurality of representative probabilities associated with a plurality of given entities being present in list of common words that connect a plurality of given topics in a plurality of given documents. As such, a topic-entity-common word matrix may capture semantic relationships between a plurality of entities and a plurality of topics.

In some embodiments, at step/operation 604, the computing entity 200 generates a plurality of entity-topic weights for the plurality of entities with respect to the plurality of topics based on the topic-entity-common word matrix. In some embodiments, an entity-topic weight describes an amount of importance or relationship strength of an entity with respect to a topic. An entity-topic weight may be generated based on a semantic relation between an entity and a topic. According to various embodiments of the present disclosure, a plurality of entity-topic weights is generated for a plurality of entities with respect to a plurality of topics based on a topic-entity-common word matrix.

In some embodiments, an entity-topic weight is determined based on the following:

$${w}_{te} ( {t}_{i} , {e}_{j} ) = {∅}_{i , j} \qquad Equation 3$$

for topic tᵢ and entity eⱼ, where ∅_{i,j} is element in i^{th} row and j^{th} column of topic-entity-common word matrix T_{ecwd}.

In some embodiments, at step/operation 606, the computing entity 200 generates a plurality of entity quality scores for the plurality of entities based the plurality of entity-topic weights. In some embodiments, an entity quality score describes diversification and richness associated with an entity. According to various embodiments of the present disclosure, a plurality of entity quality scores is generated for a plurality of entities based a plurality of entity-topic weights. In some embodiments, an entity quality score is generated based on a summation comprising a plurality of probabilities associated with a plurality of entities being present within a plurality of common words that connect a plurality of topics with respect to a given topic, for a plurality of topics.

In some embodiments, an entity quality score is determined based on the following:

$$Entity Quality ( EQ ) = {\sum }_{m = 1}^{\vert T \vert} {\sum }_{n = 1}^{\vert E \vert} {∅}_{m , n} \qquad Equation 4$$

In some embodiments, generating the one or more document-topic-entity relationship features comprises generating a plurality of similarity scores for a plurality of mention-context vector and topic-entity-mention vector pairs. In some embodiments, a similarity score describes a measure of how alike data objects are to each other. A similarity score may be generated by comparing one or more values of one or more data features that are associated with a first data object with respective one or more values of one or more data features that are associated with a second data object. In some embodiments, the plurality of similarity scores is generated based on a plurality of mention-context vector and topic-entity-mention vector pairs.

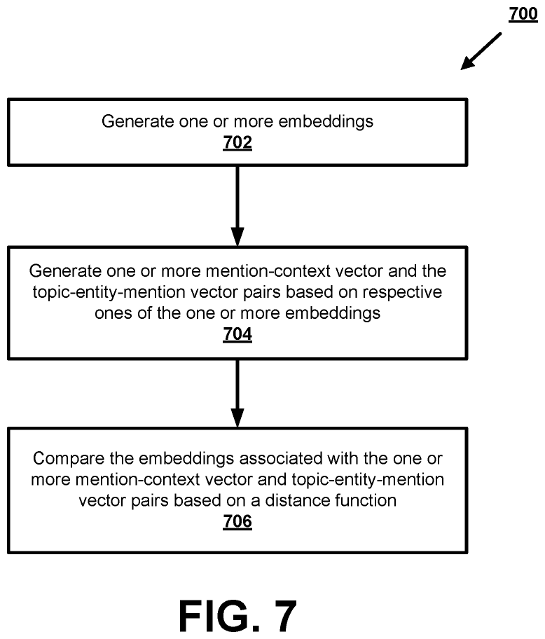

FIG. 7 is a flowchart diagram of an example process 700 for generating a plurality of similarity scores in accordance with some embodiments of the present disclosure.

In some embodiments, the process 700 begins at step/operation 702 when the computing entity 200 generates one or more embeddings for one or more of a document, a mention, a topic, an entity word, or an entity class representation. In some embodiments, an embedding describes a latent representation of a data object. For example, an embedding may be expressed as a vector comprising one or more numbers representative of one or more data features or variables associated with a data object. In some embodiments, an embedding may be generated by mapping one or more data features of a data object to one or more elements in a feature vector space.

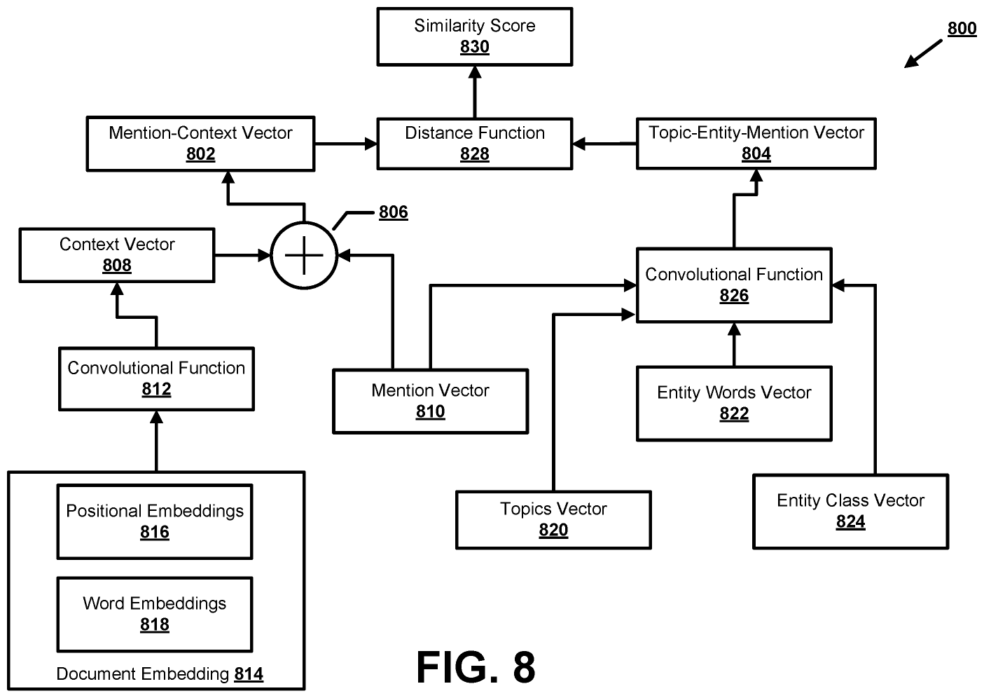

In some embodiments, at step/operation 704, the computing entity 200 generates one or more mention-context vector and topic-entity-mention vector pairs based on respective ones of the one or more embeddings. FIG. 8 depicts an example architecture for determining a similarity score 830 between a mention-context vector 802 and topic-entity-mention vector 804 pair in accordance with some embodiments of the present disclosure.

In some embodiments, a mention-context vector and topic-entity-mention vector pair is associated with a mention-context vector 802 and a topic-entity-mention vector 804. A mention-context vector 802 comprises a concatenation 806 of embeddings comprising a context vector 808 and a mention vector 810. In some embodiments, a context vector 808 comprises a condensed representation of a document. A context vector 808 may be generated by applying a convolutional function 812 on a document embedding 814 comprising one or more positional (e.g., position of words, sentences, paragraphs) embeddings 816 and one or more word embeddings 818. In some embodiments, a mention vector 810 comprises a representation of a mention. A mention may comprise a keyword that is representative of a document and may be used to retrieve or reference the document when included in a query.

In some embodiments, a topic-entity-mention vector 804 comprises a convolution (e.g., application of a convolutional function 826) of embeddings comprising the mention vector 810, a topics vector 820, an entity words vector 822, and an entity class representation vector 824. In some embodiments, a topics vector 820 comprises a representation of one or more topics associated with the mention. In some embodiments, an entity words vector 822 comprises a representation of one or more entity names associated with the mention. In some embodiments, an entity class representation vector 824 comprises a representation of one or more entity classes associated with the mention.

Returning to FIG. 7, in some embodiments, at step/operation 704, the computing entity 200 compares the embeddings associated with the one or more mention-context vector and topic-entity-mention vector pairs based on a distance function. A distance function (e.g., distance function 828) may comprise a mathematical formula that may be used to calculate a distance, such as Euclidean distance, Manhattan distance, Minkowski distance, Jaccard distance, Cosine similarity, and any other types of distance measurements apparent to one of ordinary skill in the art, between the embeddings associated with the pair of mention-context vector 802 and topic-entity-mention vector 804. A similarity score 830 between mention-context vector 802 and topic-entity-mention vector 804 may be generated based on the distance function 828. In some embodiments, associations between one or more entities and topics associated with topic-entity-mention vectors and the mention-context vectors are generated based on the comparison.

Returning to FIG. 4, in some embodiments, at step/operation 404, the computing entity 200 generates one or more knowledge graph data objects based on the one or more document-topic-entity relationship features.

In some embodiments, a knowledge graph data object describes a network of one or more data elements and one or more relationships between the one or more data elements. In some embodiments, the one or more data elements comprise nodes that are representative of topics, entities, or documents. According to various embodiments of the present disclosure, a knowledge graph data object comprises a representation of interrelationships between topics, entities, and documents. In some embodiments, a knowledge graph data object comprises (i) a plurality of nodes associated with one or more topics, one or more entities, or one or more documents and (ii) a plurality of edges between the plurality of nodes.

In some example embodiments, weights and edges (e.g., links) between nodes of a knowledge graph data object are generated based on one or more of (i) a document-topic distribution matrix, (ii) a plurality of topic-document weights for a plurality of topics with respect to a plurality of documents based on the document-topic distribution matrix, (iii) a plurality of topic randomness scores for the plurality of topics based on the plurality of topic-document weights, (iv) a topic-entity-common word matrix, (v) a plurality of entity-topic weights for a plurality of entities with respect to the plurality of topics based on the topic-entity-common word matrix, (vi) a plurality of entity quality scores for the plurality of entities based the plurality of entity-topic weights, or (vii) a plurality of similarity scores associated with the plurality of entities, the plurality of topics, or the plurality of documents.

In some embodiments, at step/operation 406, the computing entity 200 generates one or more prompt elements based on a query input. A query input may comprise a request for information. For example, a query input may comprise one or more words, terms, or a string of characters, numbers, symbols, or any combination thereof, that may be entered by a user and received by a computing system 101 and/or computing entity 200 from one or more client computing entities 102, either directly or indirectly via, e.g., an information retrieval system comprising a search engine. A query input may be used by an information retrieval system to match the query input with a corpus of content items or data objects for retrieval. In some embodiments, a query input comprises one or more query topics, one or more query entities, or one or more query documents. According to various embodiments of the present disclosure, one or more prompt elements are generated based on one or more query topics, one or more query entities, or one or more query documents associated with a query input.

In some embodiments, a prompt element describes a building block or component from which a prompt (e.g., usable to request a desired output from a machine learning model, such as a natural language processing machine learning model) may be generated from. A prompt element may comprise information associated with an aspect of a desired output to be generated by a machine learning model or necessary information for generating the desired output by the machine learning model. For example, a prompt may be generated based on one or more prompt elements comprising parameters for guiding, requesting, or directing a machine learning model towards a desired output.

In some embodiments, the one or more prompt elements comprise one or more of (i) context data associated with one or more query topics, one or more query entities, or one or more query documents, (ii) one or more knowledge graph data objects, (iii) one or more historic queries, or (iv) one or more prompt templates.

In some embodiments, a prompt template describes a sample prompt comprising predefined information or instructions. In some embodiments, a prompt is generated based on a prompt element comprising one or more prompt templates. In some embodiments, a prompt is generated by selecting a prompt template and populating the prompt template with information or instructions based on one or more prompt elements that are generated based on a query input.

In some embodiments, context data describes information associated with a set of facts or circumstances that are used to guide (e.g., via a prompt) a machine learning model, such as a natural language processing machine learning model, to generate an output.

In some embodiments, a historic query describes a query input that has been previously received by a query input receiving system, such as an information retrieval system and/or a search engine.

In some embodiments, at step/operation 408, the computing entity 200 generates, using a natural language processing machine learning model, one or more subgraph data objects based on a prompt comprising the one or more prompt elements.

In some embodiments, a subgraph data object describes a network of one or more data elements (e.g., nodes and edges associated with topics, entities, or documents) and one or more relationships between the one or more data elements, wherein the one or more data elements and the one or more relationships are extracted, by a machine learning model, based on one or more knowledge graph data objects. In some embodiments, one or more subgraph data objects (e.g., for generating answer outputs) are generated by determining one or more documents and/or entities that are high ranking with respect to a query input based on (i) the one or more knowledge graph data objects and/or (ii) a knowledge base comprising one or more document-topic-entity relationship features and rankings associated with the one or more documents and/or entities. In some embodiments, generating one or more subgraph data objects comprises determining one or more attributes, such as radius of graph, graph periphery or node pairwise short path length, that are associated with one or more edges between documents and/or entities from one or more knowledge graph data object.

In some embodiments, generating the one or more subgraph data objects comprises retrieving top ranked (k_{doc}) set of documents [D₁, D₂, D₃ . . . Dₖ_{_{doc}} and top ranked (kₑₙₜ) set of entities [E₁, E₂, E₃ . . . Eₖ_{ₑₙₜ}]. The top ranked entities may be used to retrieve entity links [E₁, E₂, E₃ . . . Eₙ∈D] from the one or more knowledge graph data objects, thereby generating the one or more subgraph data objects.

In some embodiments, generating one or more subgraph data object comprises (i) generating a prompt based on one of one or more prompt templates, (ii) generating a question based on the one or more prompt templates and one or more of (a) context data associated with a query input, (b) one or more knowledge graph data objects, or (c) one or more historic queries, and (iii) generating, using a natural language processing machine learning model, an answer based on the question.

In some embodiments, a prompt describes information comprising one or more instructions that may be used to interact with a machine learning model, such as a natural language processing machine learning model, to define a desired output. That is, a prompt may be used to provide a machine learning model with information the machine learning model needs to generate a desired output. For example, a machine learning model may generate an answer to a question (or a response to a query) based on a prompt comprising context, rules, parameters, steps, or actions for generating the output. In some embodiments, a prompt comprises instructions for directing a machine learning model to generate an output by (i) extracting one or more nodes (e.g., topics, entities, and documents) from a prompt, (ii) classifying the one or more nodes into one or more subdomains, and (iii) generating one or more subgraph data objects for the one or more subdomains based on the classified nodes and one or more knowledge graph data objects.

In some embodiments, a natural language processing machine learning model describes parameters, hyperparameters, and/or defined operations of a machine learning model that is configured to recognize, translate, predict, or generate text or other content. For example, a natural language processing machine learning model may be used for text classification, question answering, document summarization, and text generation. In some embodiments, a natural language processing machine learning model comprises a transformer machine learning model that is configured to receive an input, encode the input (e.g., via an encoder), and decode the encoded input (e.g., via a decoder) to produce an output prediction. In some embodiments, a natural language processing machine learning model may be trained on a voluminous amount of datasets (e.g., an LLM).

In some embodiments, at step/operation 410, the computing entity 200 generates (or provides) one or more answer outputs based on the one or more subgraph data objects. In some embodiments, an answer output describes a response to a query input. For example, an answer output may comprise any one of information, predictions, or content items (e.g., provided as search results). The one or more answer outputs may be visually rendered and displayed on a prediction output user interface.

According to various embodiments of the present disclosure, generating the one or more answer outputs comprises traversing the one or more subgraph data objects and identifying one or more entities and/or one or more documents from the one or more subgraph data objects that are relevant to the query input based on the traversal of the one or more subgraph data objects. In some embodiments, the one or more subgraph data objects may be traversed by (i) following topic-entity-topic vertices, tᵢ↔eⱼ↔tₖ, where eⱼ is selected based on a pre-condition with respect to tᵢ and its selection probability is,

$$\frac{{∅}_{i , j}}{{\sum }_{{e}_{k} ∈ E} {∅}_{i , k}} \qquad Equation 5$$

for eⱼ∈E, and similarly a probability of picking tₖ is,

$$\frac{{∅}_{k , j}}{{\sum }_{{t}_{k} ∈ T} {∅}_{k , j}} \qquad Equation 6$$

which is preconditioned on eⱼ, (ii) following topic-document-topic vertices, tᵢ↔dⱼ↔tₖ, where dⱼ is selected based on a pre-condition with respect to tᵢ and its selection probability is,

$$\frac{{θ}_{i , j}}{{\sum }_{{d}_{k} ∈ D} {θ}_{i , k}} \qquad Equation 7$$

for dⱼ∈D, and similarly a probability of picking tₖ is,

$$\frac{{θ}_{k , j}}{{\sum }_{{t}_{k} ∈ T} {θ}_{k , j}} \qquad Equation 8$$

which is preconditioned on dⱼ, or (iii) directly landing on entities/topics with no edges, where the probability of landing directly on an entity may be determined by the following initial probability:

$$P ( {t}_{i} ) = \frac{1}{\vert D \vert} ( {\sum }_{j = 1}^{\vert D \vert} {θ}_{j , i} ) .$$

The following is an example algorithm for identifying one or more entities and/or one or more documents from the one or more subgraph data objects:

```
  1. for each dⱼ ∈ D do
    a. n(dⱼ) = 0 // document nodes
  2. end for
  3. for each tᵢ ∈ T do
    a. n(tᵢ) = 0 // topic nodes
  4. end for
  5. for each eⱼ ∈ E do
    a. n(eⱼ) = 0 // enity nodes
  6. end for
  7. // initiate retriever
  8. Select tᵢ ∈ T as starting point with probability score of P(tᵢ)
  9. While converge do
    a. If P(tᵢ) < Ø_{i,j} then
      i. Select tᵢ ↔ eⱼ ↔ tₖ; tᵢ, tₖ ∈ T, eⱼ ∈ E
      ii. n(tᵢ) = n(tᵢ) + 1, n(eⱼ) = n(eⱼ) + 1, n(tₖ) = n(tₖ) + 1
    b. elseif P(tᵢ) < θ_{i,j} then
      i. Select tᵢ ↔ dⱼ ↔ tₖ; tᵢ, tₖ ∈ T, dⱼ ∈ D
      ii. n(tᵢ) = n(tᵢ) + 1, n(dⱼ) = n(dⱼ) + 1, n(tₖ) = n(tₖ) + 1
    c. else
      i. Directly lands on set of entities.
      ii. n(eᵢ) eᵢ ∈ E ∈ T ∈ D
10. endif
11. for each eᵢ ∈ E do
    $a . {\sum }_{i = 1}^{\vert E \vert} r ( {e}_{i} ) = \frac{s ( {e}_{i} )}{{\sum }_{{e}_{j = 1} ∈ E}^{k} s ( {e}_{j} )}$
12. end for
13. Return sub graph ranked by number of visits during retrieval
    computation (convergence)
```

In some embodiments, generating an answer output comprises determining whether sufficient knowledge is available (e.g., to the natural language processing machine learning model) to generate the answer output. For example, determining sufficient knowledge to generate the answer output may comprise determining whether one or more subgraph data objects may be generated based on one or more query topics, one or more query entities, or one or more query documents from context data based on a query input.

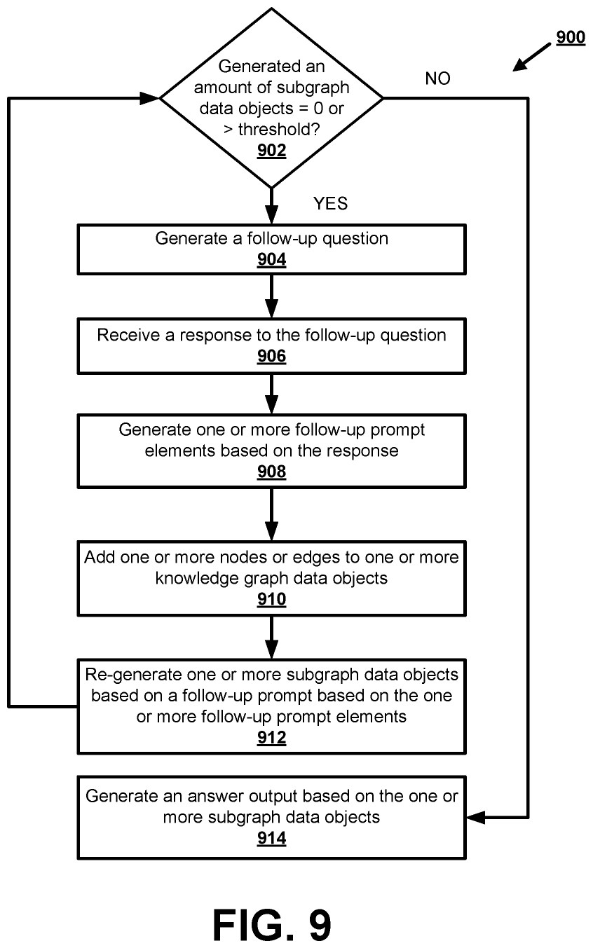

FIG. 9 is a flowchart diagram of an example process 900 for providing sufficient knowledge to generate an answer output in accordance with some embodiments of the present disclosure.

In some embodiments, the process 900 begins at step/operation 902 when the computing entity 200 determines whether an amount of subgraph data objects generated based on a prompt is zero or greater than a threshold. Generating a zero amount of subgraph data objects (e.g., an inability to generate subgraph data objects) or an amount of subgraph data objects greater than a threshold may be representative of insufficient or vagueness of a prompt or query input.

In some embodiments, if the amount of subgraph data objects is not zero and less than the threshold, at step/operation 914, the computing entity 200 generates an answer output based on the one or more subgraph data objects.

In some embodiments, at step/operation 904, if the amount of subgraph data objects is zero or greater than the threshold, the computing entity 200 generates a follow-up question based on a query input, one or more subgraph data objects (if generated), or one or more knowledge graph data objects. For example, the follow-up question may comprise solicitation for additional information or to refine a query input.

In some embodiments, at step/operation 906, the computing entity 200 receives a response to the follow-up question.

In some embodiments, at step/operation 908, the computing entity 200 generates one or more follow-up prompt elements based on the response.

In some embodiments, at step/operation 910, the computing entity 200 adds one or more nodes or edges to one or more knowledge graph data objects, associated with the one or more subgraph data objects, based on the one or more follow-up prompt elements.

In some embodiments, at step/operation 912, the computing entity 200 re-generates one or more subgraph data objects based on a follow-up prompt based on the one or more follow-up prompt elements.

In some embodiments, steps/operations 902 through 912 are repeated until the computing entity 200 determines that the amount of subgraph data objects is not zero and less than the threshold.

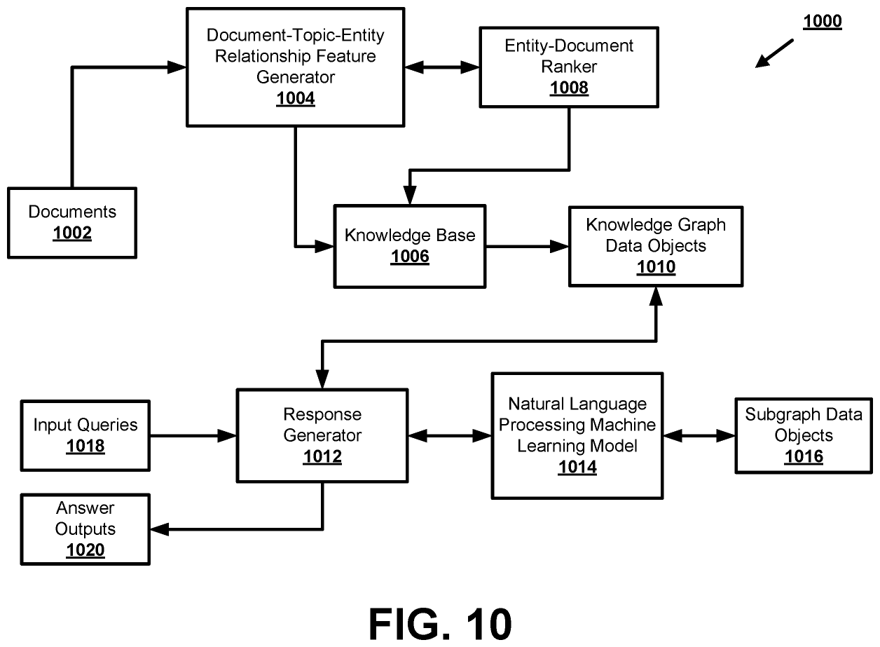

FIG. 10 depicts an example search system architecture 1000 in accordance with some embodiments of the present disclosure. Documents 1002 may be processed by a document-topic-entity relationship feature generator 1004 to generate a respective plurality of document-topic-entity relationship features associated with the documents 1002. Entity-document ranker 1008 may generate rankings for a plurality of entities with respect to a plurality of documents, e.g., based on similarity scores as described herewith. The rankings generated by entity-document ranker 1008 may also be based on topic randomness scores and entity quality scores.

A knowledge base 1006 may comprise the plurality of document-topic-entity relationship features generated by document-topic-entity relationship feature generator 1004 and the rankings generated by entity-document ranker 1008. Knowledge graph data objects 1010 may comprise nodes, edges, and edge weights generated based on the knowledge base 1006.

A response generator 1012 may receive input queries 1018 and generate prompts comprising prompt elements (e.g., (i) context data associated with one or more query topics, one or more query entities, or one or more query documents, (ii) one or more knowledge graph data objects, (iii) one or more historic queries, or (iv) one or more prompt templates) based the input queries 1018. The prompts may be provided to natural language processing machine learning model 1014 to generate subgraph data objects 1016. The subgraph data objects 1016 may be generated by extracting portions (e.g., nodes and edges associated with topics, entities, or documents) of the knowledge graph data objects 1010 based on prompts provided to the natural language processing machine learning model 1014.

The subgraph data objects 1016 may be provided by the natural language processing machine learning model 1014 to the response generator 1012 to generate answer outputs 120. The answer outputs 1020 may be generated by traversing the subgraph data objects 1016 and identifying one or more entities and/or one or more documents from the subgraph data objects 1016 that are relevant to input queries 1018 based on the traversal of the subgraph data objects 1016.

Accordingly, as described above, various embodiments of the present disclosure make important technical contributions to improving the predictive accuracy of predictive machine learning models by generating prompts based on context data and a reference to one or more knowledge graph data objects that are extracted from query inputs. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative machine learning model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

Some techniques of the present disclosure enable the generation of subgraphs that may be used to generate responses to query inputs. The techniques of the present disclosure may be used, applied, and/or otherwise leveraged to generate prompts based on context data and a reference to one or more knowledge graph data objects that are extracted from query input, which may help in the computer interpretation of relationships between topics, entities, and documents. The natural language processing machine learning model of the present disclosure may be leveraged to generate responses to search queries that improve the performance of a computing system (e.g., a computer itself, etc.) with respect to various predictive actions performed by the computing entity 200, such as for the generating of prompts based on query inputs and the generating of answer outputs based on the prompts, and/or the like.

In some examples, the answer outputs may include predictive actions that may be based on a prediction domain. A prediction domain may include any environment in which computing systems may be applied to achieve real-word insights, such as predictions (e.g., entity-document relationships), and initiate the performance of computing tasks, such as prediction actions to act on the real-world insights. These predictive actions may cause real-world changes, for example, by controlling a hardware component, providing alerts, interactive actions, and/or the like.

Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: receiving, by one or more processors, one or more knowledge graph data objects comprising (i) a plurality of nodes associated with a plurality of topics, a plurality of entities, or a plurality of documents and (ii) a plurality of edges between the plurality of nodes; generating, by the one or more processors and based on a query input, one or more prompt elements by associating context data with the one or more knowledge graph data objects, wherein the context data is further associated with one or more query topics, one or more query entities, or one or more query documents; generating, by the one or more processors and using a natural language processing machine learning model, one or more subgraph data objects based on a prompt comprising the one or more prompt elements; and providing, by the one or more processors, one or more answer outputs based on the one or more subgraph data objects.

Example 2. The computer-implemented method of example 1, wherein the one or more knowledge graph data objects are previously generated based on one or more document-topic-entity relationship features that are associated with the plurality of topics, the plurality of entities, and the plurality of documents, and the one or more document-topic-entity relationship features are generated by generating one or more of (i) a document-topic distribution matrix, (ii) a topic-entity-common word matrix, (iii) a plurality of topic-document weights, (iv) a plurality of entity-topic weights, (v) a plurality of topic randomness scores, (vi) a plurality of entity quality scores, or (vii) a plurality of similarity scores associated with the plurality of entities, the plurality of topics, or the plurality of documents.

Example 3. The computer-implemented method of example 2, wherein the one or more knowledge graph data objects are previously generated based on one or more document-topic-entity relationship features that are associated with the plurality of topics, the plurality of entities, and the plurality of documents, and the one or more document-topic-entity relationship features are generated by: generating a document-topic distribution matrix that comprises a distribution of the plurality of topics with respect to the plurality of documents; generating a plurality of topic-document weights for the plurality of topics with respect to the plurality of documents based on the document-topic distribution matrix; and generating a plurality of topic randomness scores for the plurality of topics based on the plurality of topic-document weights.

Example 4. The computer-implemented method of any of the preceding examples, wherein generating the one or more document-topic-entity relationship features comprises: generating a topic-entity-common word matrix comprising a distribution of the plurality of entities within a plurality of common words that connect the plurality of topics with respect to the plurality of topics in the plurality of documents; generating a plurality of entity-topic weights for the plurality of entities with respect to the plurality of topics based on the topic-entity-common word matrix; and generating a plurality of entity quality scores for the plurality of entities based the plurality of entity-topic weights.

Example 5. The computer-implemented method of any of the preceding examples, wherein the one or more knowledge graph data objects are previously generated based on one or more document-topic-entity relationship features that are associated with the plurality of topics, the plurality of entities, and the plurality of documents, and the one or more document-topic-entity relationship features are generated by generating a plurality of similarity scores for a plurality of mention-context vector and topic-entity-mention vector pairs.

Example 6. The computer-implemented method of any of the preceding examples, wherein the natural language processing machine learning model comprises a transformer machine learning model.

Example 7. The computer-implemented method of any of the preceding examples, wherein the one or more prompt elements further comprise (i) one or more historic queries, or (ii) one or more prompt templates.

Example 8. The computer-implemented method of example 7, wherein generating the one or more subgraph data objects comprises: generating the prompt based on one of the one or more prompt templates; generating a question based on the one or more prompt templates and one or more of (a) the context data, (b) the one or more knowledge graph data objects, or (c) the one or more historic queries; and generating, using the natural language processing machine learning model, an answer based on the question.

Example 9. The computer-implemented method of any of the preceding examples, wherein generating the one or more answer outputs comprises determining an amount of the one or more subgraph data objects is zero or exceeds a threshold representative of the query input comprising an ambiguity; generating a follow-up question based on the query input, the one or more subgraph data objects, or the one or more knowledge graph data objects; receiving a response to the follow-up question; generating one or more follow-up prompt elements based on the response; and adding one or more nodes or edges to the one or more knowledge graph data objects based on the one or more follow-up prompt elements.

Example 10. The computer-implemented method of any of the preceding examples, wherein generating the one or more answer outputs comprises: traversing the one or more subgraph data objects; and identifying one or more entities or one or more documents from the one or more subgraph data objects that are relevant to the query input based on the traversal.

Example 11. A computing system comprising memory and one or more processors communicatively coupled to the memory, the one or more processors configured to receive one or more knowledge graph data objects comprising (i) a plurality of nodes associated with a plurality of topics, a plurality of entities, or a plurality of documents and (ii) a plurality of edges between the plurality of nodes; generate, based on a query input, one or more prompt elements by associating context data with the one or more knowledge graph data objects, wherein the context data is further associated with one or more query topics, one or more query entities, or one or more query documents; generate, using a natural language processing machine learning model, one or more subgraph data objects based on a prompt comprising the one or more prompt elements; and providing one or more answer outputs based on the one or more subgraph data objects.

Example 12. The computing system of example 11, wherein the one or more knowledge graph data objects are previously generated based on one or more document-topic-entity relationship features that are associated with the plurality of topics, the plurality of entities, and the plurality of documents, and the one or more document-topic-entity relationship features are generated by generating one or more of (i) a document-topic distribution matrix, (ii) a topic-entity-common word matrix, (iii) a plurality of topic-document weights, (iv) a plurality of entity-topic weights, (v) a plurality of topic randomness scores, (vi) a plurality of entity quality scores, or (vii) a plurality of similarity scores associated with the plurality of entities, the plurality of topics, or the plurality of documents.

Example 13. The computing system of any of example 12, wherein the one or more knowledge graph data objects are previously generated based on one or more document-topic-entity relationship features that are associated with the plurality of topics, the plurality of entities, and the plurality of documents, and the one or more document-topic-entity relationship features are generated by: generating a document-topic distribution matrix that comprises a distribution of the plurality of topics with respect to the plurality of documents; generating a plurality of topic-document weights for the plurality of topics with respect to the plurality of documents based on the document-topic distribution matrix; and generating a plurality of topic randomness scores for the plurality of topics based on the plurality of topic-document weights.

Example 14. The computing system of any of examples 11 through 13, wherein the one or more processors are configured to generate the one or more document-topic-entity relationship features by: generating a topic-entity-common word matrix comprising a distribution of the plurality of entities within a plurality of common words that connect the plurality of topics with respect to the plurality of topics in the plurality of documents; generating a plurality of entity-topic weights for the plurality of entities with respect to the plurality of topics based on the topic-entity-common word matrix; and generating a plurality of entity quality scores for the plurality of entities based the plurality of entity-topic weights.

Example 15. The computing system of any of examples 11 through 14, wherein the one or more prompt elements further comprise (i) one or more historic queries, or (ii) one or more prompt templates.

Example 16. The computing system of example 15, wherein the one or more processors are configured to generate the one or more subgraph data objects by: generating the prompt based on one of the one or more prompt templates; generating a question based on the one or more prompt templates and one or more of (a) the context data, (b) the one or more knowledge graph data objects, or (c) the one or more historic queries; and generating, using the natural language processing machine learning model, an answer based on the question.

Example 17. The computing system of any of examples 11 through 16, wherein the one or more processors are configured to generate the one or more answer outputs by: determining an amount of the one or more subgraph data objects is zero or exceeds a threshold representative of the query input comprising an ambiguity; generating a follow-up question based on the query input, the one or more subgraph data objects, or the one or more knowledge graph data objects; receiving a response to the follow-up question; generating one or more follow-up prompt elements based on the response; and adding one or more nodes or edges to the one or more knowledge graph data objects based on the one or more follow-up prompt elements.

Example 18. One or more non-transitory computer-readable storage media including instructions that, when executed by one or more processors, cause the one or more processors to: receive one or more knowledge graph data objects comprising (i) a plurality of nodes associated with a plurality of topics, a plurality of entities, or a plurality of documents and (ii) a plurality of edges between the plurality of nodes; generate, based on a query input, one or more prompt elements by associating context data with the one or more knowledge graph data objects, wherein the context data is further associated with one or more query topics, one or more query entities, or one or more query documents; generate, using a natural language processing machine learning model, one or more subgraph data objects based on a prompt comprising the one or more prompt elements; and provide one or more answer outputs based on the one or more subgraph data objects.

Example 19. The one or more non-transitory computer-readable storage media of example 18 wherein the one or more knowledge graph data objects are previously generated based on one or more document-topic-entity relationship features that are associated with the plurality of topics, the plurality of entities, and the plurality of documents, and the one or more document-topic-entity relationship features are generated by generating one or more of (i) a document-topic distribution matrix, (ii) a topic-entity-common word matrix, (iii) a plurality of topic-document weights, (iv) a plurality of entity-topic weights, (v) a plurality of topic randomness scores, (vi) a plurality of entity quality scores, or (vii) a plurality of similarity scores associated with the plurality of entities, the plurality of topics, or the plurality of documents.

Example 20. The one or more non-transitory computer-readable storage media of examples 18 or 19 further including instructions that, when executed by the one or more processors, cause the one or more processors to generate the one or more answer outputs by: determining an amount of the one or more subgraph data objects is zero or exceeds a threshold representative of the query input comprising an ambiguity; generating a follow-up question based on the query input, the one or more subgraph data objects, or the one or more knowledge graph data objects; receiving a response to the follow-up question; generating one or more follow-up prompt elements based on the response; and adding one or more nodes or edges to the one or more knowledge graph data objects based on the one or more follow-up prompt elements.

Example 21. The computer-implemented method of example 1, wherein the natural language processing machine learning model comprises a transformer machine learning model and the method further comprises training the transformer machine learning model to generate the one or more subgraph data objects based on the prompt.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The computing system of example 11, wherein the natural language processing machine learning model comprises a transformer machine learning model and the method further comprises training the transformer machine learning model to generate the one or more subgraph data objects based on the prompt.

Example 25. The computing system of example 24, wherein the training is performed by the one or more processors.

Example 26. The computing system of example 24, wherein the one or more processors are included in a first computing entity; and the training is performed by one or more other processors included in a second computing entity.

Example 27. The one or more non-transitory computer-readable storage media of example 18, wherein the natural language processing machine learning model comprises a transformer machine learning model and the method further comprises training the transformer machine learning model to generate the one or more subgraph data objects based on the prompt.

Example 28. The one or more non-transitory computer-readable storage media of example 27, wherein the training is performed by the one or more processors.

Example 29. The one or more non-transitory computer-readable storage media of example 27, wherein the one or more processors are included in a first computing entity; and the training is performed by one or more other processors included in a second computing entity.

1. A computer-implemented method comprising:
receiving, by one or more processors, one or more knowledge graph data objects comprising (i) a plurality of nodes associated with a plurality of topics, a plurality of entities, or a plurality of documents and (ii) a plurality of edges between the plurality of nodes;
generating, by the one or more processors and based on a query input, one or more prompt elements by associating context data with the one or more knowledge graph data objects, wherein the context data is further associated with one or more query topics, one or more query entities, or one or more query documents;
generating, by the one or more processors and using a natural language processing machine learning model, one or more subgraph data objects based on a prompt comprising the one or more prompt elements; and
providing, by the one or more processors, one or more answer outputs based on the one or more subgraph data objects.

2. The computer-implemented method of claim 1, wherein the one or more knowledge graph data objects are previously generated based on one or more document-topic-entity relationship features that are associated with the plurality of topics, the plurality of entities, and the plurality of documents, and the one or more document-topic-entity relationship features are generated by generating one or more of (i) a document-topic distribution matrix, (ii) a topic-entity-common word matrix, (iii) a plurality of topic-document weights, (iv) a plurality of entity-topic weights, (v) a plurality of topic randomness scores, (vi) a plurality of entity quality scores, or (vii) a plurality of similarity scores associated with the plurality of entities, the plurality of topics, or the plurality of documents.

3. The computer-implemented method of claim 2, wherein the one or more knowledge graph data objects are previously generated based on one or more document-topic-entity relationship features that are associated with the plurality of topics, the plurality of entities, and the plurality of documents, and the one or more document-topic-entity relationship features are generated by:
generating a document-topic distribution matrix that comprises a distribution of the plurality of topics with respect to the plurality of documents;
generating a plurality of topic-document weights for the plurality of topics with respect to the plurality of documents based on the document-topic distribution matrix; and
generating a plurality of topic randomness scores for the plurality of topics based on the plurality of topic-document weights.

4. The computer-implemented method of claim 1, wherein the one or more knowledge graph data objects are previously generated based on one or more document-topic-entity relationship features that are associated with the plurality of topics, the plurality of entities, and the plurality of documents, and the one or more document-topic-entity relationship features are generated by:
generating a topic-entity-common word matrix comprising a distribution of the plurality of entities within a plurality of common words that connect the plurality of topics with respect to the plurality of topics in the plurality of documents;
generating a plurality of entity-topic weights for the plurality of entities with respect to the plurality of topics based on the topic-entity-common word matrix; and
generating a plurality of entity quality scores for the plurality of entities based the plurality of entity-topic weights.

5. The computer-implemented method of claim 1, wherein the one or more knowledge graph data objects are previously generated based on one or more document-topic-entity relationship features that are associated with the plurality of topics, the plurality of entities, and the plurality of documents, and the one or more document-topic-entity relationship features are generated by generating a plurality of similarity scores for a plurality of mention-context vector and topic-entity-mention vector pairs.

6. The computer-implemented method of claim 1, wherein the natural language processing machine learning model comprises a transformer machine learning model.

7. The computer-implemented method of claim 1, wherein the one or more prompt elements further comprise (i) one or more historic queries, or (ii) one or more prompt templates.

8. The computer-implemented method of claim 7, wherein generating the one or more subgraph data objects comprises:
generating the prompt based on one of the one or more prompt templates;
generating a question based on the one or more prompt templates and one or more of (a) the context data, (b) the one or more knowledge graph data objects, or (c) the one or more historic queries; and
generating, using the natural language processing machine learning model, an answer based on the question.

9. The computer-implemented method of claim 1, wherein generating the one or more answer outputs comprises:
determining an amount of the one or more subgraph data objects is zero or exceeds a threshold representative of the query input comprising an ambiguity;
generating a follow-up question based on the query input, the one or more subgraph data objects, or the one or more knowledge graph data objects;
receiving a response to the follow-up question;
generating one or more follow-up prompt elements based on the response; and
adding one or more nodes or edges to the one or more knowledge graph data objects based on the one or more follow-up prompt elements.

10. The computer-implemented method of claim 1, wherein generating the one or more answer outputs comprises:
traversing the one or more subgraph data objects; and
identifying one or more entities or one or more documents from the one or more subgraph data objects that are relevant to the query input based on the traversal.

11. A computing system comprising memory and one or more processors communicatively coupled to the memory, the one or more processors configured to:
receive one or more knowledge graph data objects comprising (i) a plurality of nodes associated with a plurality of topics, a plurality of entities, or a plurality of documents and (ii) a plurality of edges between the plurality of nodes;
generate, based on a query input, one or more prompt elements by associating context data with the one or more knowledge graph data objects, wherein the context data is further associated with one or more query topics, one or more query entities, or one or more query documents;
generate, using a natural language processing machine learning model, one or more subgraph data objects based on a prompt comprising the one or more prompt elements; and
provide one or more answer outputs based on the one or more subgraph data objects.

12. The computing system of claim 11, wherein the one or more knowledge graph data objects are previously generated based on one or more document-topic-entity relationship features that are associated with the plurality of topics, the plurality of entities, and the plurality of documents, and the one or more document-topic-entity relationship features are generated by generating one or more of (i) a document-topic distribution matrix, (ii) a topic-entity-common word matrix, (iii) a plurality of topic-document weights, (iv) a plurality of entity-topic weights, (v) a plurality of topic randomness scores, (vi) a plurality of entity quality scores, or (vii) a plurality of similarity scores associated with the plurality of entities, the plurality of topics, or the plurality of documents.

13. The computing system of claim 12, wherein the one or more knowledge graph data objects are previously generated based on one or more document-topic-entity relationship features that are associated with the plurality of topics, the plurality of entities, and the plurality of documents, and the one or more document-topic-entity relationship features are generated by:
generating a document-topic distribution matrix that comprises a distribution of the plurality of topics with respect to the plurality of documents;
generating a plurality of topic-document weights for the plurality of topics with respect to the plurality of documents based on the document-topic distribution matrix; and
generating a plurality of topic randomness scores for the plurality of topics based on the plurality of topic-document weights.

14. The computing system of claim 11, wherein the one or more processors are configured to generate the one or more document-topic-entity relationship features by:
generating a topic-entity-common word matrix comprising a distribution of the plurality of entities within a plurality of common words that connect the plurality of topics with respect to the plurality of topics in the plurality of documents;
generating a plurality of entity-topic weights for the plurality of entities with respect to the plurality of topics based on the topic-entity-common word matrix; and
generating a plurality of entity quality scores for the plurality of entities based the plurality of entity-topic weights.

15. The computing system of claim 11, wherein the one or more prompt elements further comprise (i) one or more historic queries, or (ii) one or more prompt templates.

16. The computing system of claim 15, wherein the one or more processors are configured to generate the one or more subgraph data objects by:
generating the prompt based on one of the one or more prompt templates;
generating a question based on the one or more prompt templates and one or more of (a) the context data, (b) the one or more knowledge graph data objects, or (c) the one or more historic queries; and
generating, using the natural language processing machine learning model, an answer based on the question.

17. The computing system of claim 11, wherein the one or more processors are configured to generate the one or more answer outputs by:
determining an amount of the one or more subgraph data objects is zero or exceeds a threshold representative of the query input comprising an ambiguity;
generating a follow-up question based on the query input, the one or more subgraph data objects, or the one or more knowledge graph data objects;
receiving a response to the follow-up question;
generating one or more follow-up prompt elements based on the response; and
adding one or more nodes or edges to the one or more knowledge graph data objects based on the one or more follow-up prompt elements.

18. One or more non-transitory computer-readable storage media including instructions that, when executed by one or more processors, cause the one or more processors to:
receive one or more knowledge graph data objects comprising (i) a plurality of nodes associated with a plurality of topics, a plurality of entities, or a plurality of documents and (ii) a plurality of edges between the plurality of nodes;
generate, based on a query input, one or more prompt elements by associating context data with the one or more knowledge graph data objects, wherein the context data is further associated with one or more query topics, one or more query entities, or one or more query documents;
generate, using a natural language processing machine learning model, one or more subgraph data objects based on a prompt comprising the one or more prompt elements; and
provide one or more answer outputs based on the one or more subgraph data objects.

19. The one or more non-transitory computer-readable storage media of claim 18, wherein the one or more knowledge graph data objects are previously generated based on one or more document-topic-entity relationship features that are associated with the plurality of topics, the plurality of entities, and the plurality of documents, and the one or more document-topic-entity relationship features are generated by generating one or more of (i) a document-topic distribution matrix, (ii) a topic-entity-common word matrix, (iii) a plurality of topic-document weights, (iv) a plurality of entity-topic weights, (v) a plurality of topic randomness scores, (vi) a plurality of entity quality scores, or (vii) a plurality of similarity scores associated with the plurality of entities, the plurality of topics, or the plurality of documents.

20. The one or more non-transitory computer-readable storage media of claim 18 further including instructions that, when executed by the one or more processors, cause the one or more processors to generate the one or more answer outputs by:
determining an amount of the one or more subgraph data objects is zero or exceeds a threshold representative of the query input comprising an ambiguity;
generating a follow-up question based on the query input, the one or more subgraph data objects, or the one or more knowledge graph data objects;
receiving a response to the follow-up question;
generating one or more follow-up prompt elements based on the response; and
adding one or more nodes or edges to the one or more knowledge graph data objects based on the one or more follow-up prompt elements.
